(19) United States
(12) Patent Application Publication
(10) Pub. No.: US 2007/0016566 A1
(43) Pub. Date: Jan. 18, 2007

(54) Method and apparatus for searching data

(75) Inventors: Tzu-Ping Jan, Taipei City (TW); Jain-Shaung Yan, Taipei City (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/482,804

(22) Filed: Jul. 10, 2006

(30) Foreign Application Priority Data
Jul. 12, 2005 (TW) 094123569

(51) Int. Cl. G06F 17/30

(52) U.S. Cl. 707/3

(57) ABSTRACT

A data searching method for an electronic device that stores a plurality of string data is disclosed. The data searching method includes: generating a plurality of index values corresponding to the plurality of string data; receiving an input value sequence, and selecting at least one target data having an index value that partially matches the input value sequence from the plurality of string data.

### BACKGROUND OF THE INVENTION

1. Field of the Invention

The present invention relates to methods and apparatuses for searching data, and more particularly, to methods and apparatuses that create an index value for each candidate data and search data based on the index value.

2. Description of the Prior Art

As our modern day technologies continue to advance, many electronic products or communications devices become lighter, smaller, and more portable. For many people, the portable digital consumer electronics devices such as the mobile phone or the personal digital assistant (PDA) play very important roles in daily life and work.

The user often records many pieces of data in the mobile phone or PDA, such as: names, addresses, email addresses, phone numbers of friends, family members, or clients, and even favorite website addresses, etc. Therefore, how to let user easily and fast access data which he/she want from mass data is important for designing these product.

When the user wants to search one or multiple data from those data stored in the mobile phone or PDA, one conventional method is to utilize the selection keys to sift through those data entry by entry. As is well known in the art, the data searching efficiency of this method is not desirable, especially if there is a considerable amount of data being stored therein.

Another conventional searching method is that the user inputs the leading characters of data to be searched and then the system sifts data from a database or storage unit according to the character sequence inputted by the user. For example, if the user firstly inputs a character “a” then the system selects data whose leading character is the character “a” from the database or storage unit. If the next character the user inputs is the character “s” then the system sifts data whose second character is the character “s” from those data leading with character “a”. Subsequently, if the following character the user input is the character “u” then the system sifts data whose third character is the character “u” from those data leading with the string “as”. In this way, the amount of data matching the searching condition is gradually reduced with each successive character inputted by the user. Finally, the user is able to find the desired data from a few data matching the input sequence having used the selection keys to generate the smaller subset of data.

Unfortunately, in contrast to the computer's keyboard, the mobile phone or PDA is merely equipped with a limited number of keys, thereby negatively affecting the character inputting convenience and efficiency for the user. For example, suppose that English letters “a”, “b”, and “c” correspond to a key “2” of the mobile phone. In general, the user needs to press the key “2” three times in order to input the letter “c”. Similarly, the user needs to press a key “7” of the mobile phone four times in order to input a English letter “s”. Furthermore, if a key character to be inputted is a character other than numbers and English letters, such as a Chinese character or a Japanese character, the user needs to press several keys in order to input the character. In view of the foregoing, it can be appreciated that the data searching performance and convenience when utilizing the prior art methods need to be improved.

### SUMMARY OF THE INVENTION

It is therefore an objective of the claimed invention to provide data searching methods and related apparatuses with superior convenience and efficiency by utilization of improved searching methods.

According to an exemplary embodiment, a data searching method for an electronic device with a plurality of stored string data is disclosed. The data searching method includes: generating a plurality of index values corresponding to the plurality of string data, respectively; receiving an input value sequence, and selecting at least one target data having an index value that partially matches the input value sequence from the plurality of string data; wherein the plurality of index values and the input value sequence have a same data type.

According to an exemplary embodiment, a data searching circuit of an electronic device is disclosed comprising: a storage medium for storing a plurality of string data; an index generator coupled to the storage medium for generating a plurality of index values corresponding to the plurality of string data, respectively; and a searching module coupled to the storage medium for receiving an input value sequence, and for selecting at least one target data having an index value that partially matches the input value sequence from the plurality of string data; wherein the plurality of index values and the input value sequence have a same data type.

Additionally, another data searching method for an electronic device storing a plurality of string data is disclosed. The data searching method includes: generating a plurality of index values corresponding to the plurality of string data, respectively; receiving an input value sequence, identifying a target range according to the input value sequence; and selecting at least one target data whose index value is located within the target range from the plurality of string data; wherein the plurality of index values and the input value sequence have a same data type.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a data searching circuit in an electronic device according to a first embodiment of the present invention.

FIG. 2 is a flowchart illustrating a data searching method according to a first embodiment of the present invention.

FIG. 3 is a block diagram of a data searching circuit according to a second embodiment of the present invention.

FIG. 4 is a flowchart illustrating a data searching method according to a second embodiment of the present invention.

### DETAILED DESCRIPTION

The data searching methods and related apparatuses to be disclosed may be applied in various portable communication devices (such as mobile phone), PDAs, or other digital electronic devices. In general, many of the data stored in these electronic devices by the user are strings composed of character such as English letters, double-byte characters, numbers, or symbols. These data encompass the names, addresses, email addresses, phone numbers of friends, family members, or clients, and favorite website addresses, etc. Typically, each of these strings often includes at least one delimiter. For the purpose of explanatory convenience in the following description, all characters other than the letters, double-byte characters, and numbers are classified into delimiters, such as blank space, punctuation marks, “_”, “-”, “@”, /, “\”, and other symbols. The operations of searching these strings will be explained hereinafter.

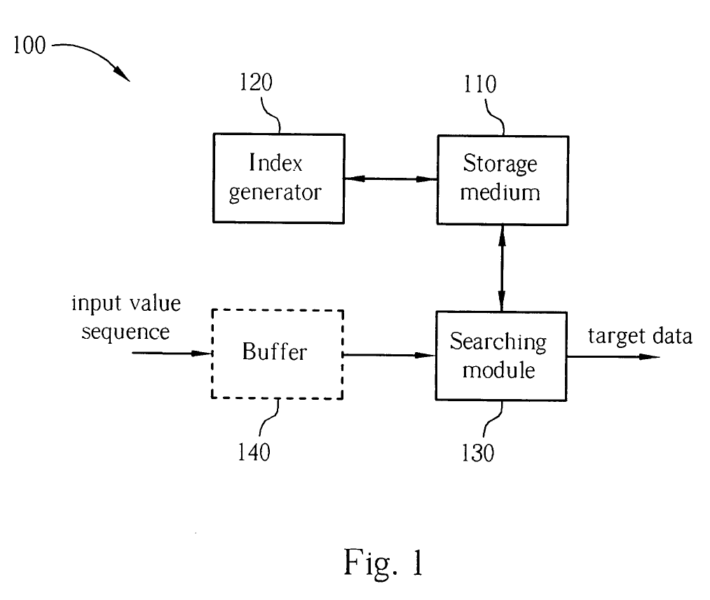

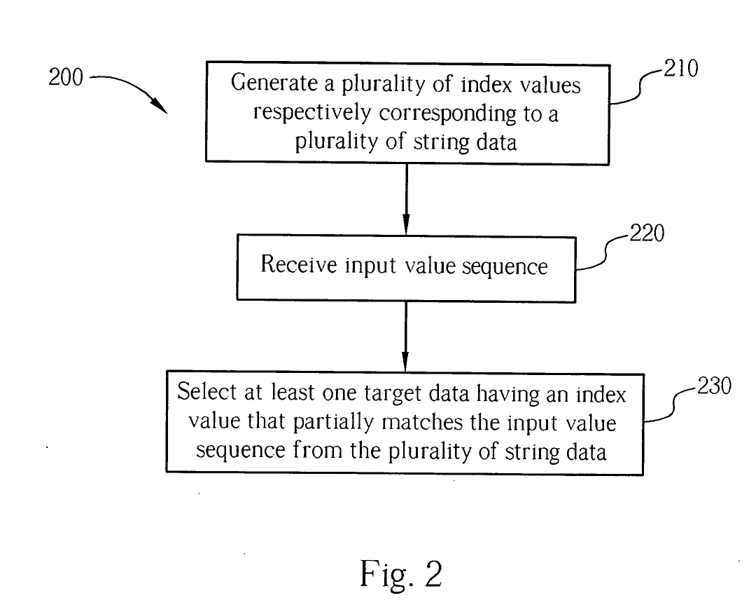

Please refer to FIG. 1 and FIG. 2. FIG. 1 shows a block diagram of a data searching circuit 100 of an electronic device according to a first embodiment of the present invention. FIG. 2 is a flowchart 200 illustrating a data searching method according to a first embodiment of the present invention. As shown in FIG. 1, the data searching circuit 100 comprises a storage medium 110 for storing a plurality of string data; an index generator 120; and a searching module 130, wherein the index generator 120 and the searching module 130 are coupled to the storage medium 110. In practice, the storage medium 110 may be a single storage component (e.g., a built-in memory of the electronic device, an external memory card, and any other optical or magnetic storage device) or a storage module consisting of different types of storage components. For the purpose of explanatory convenience in the following description, it is herein assumed that the data searching circuit 100 is applied in a mobile phone. The operations of the data searching circuit 100 will be described in more detailed with reference to FIG. 2.

In step 210, the index generator 120 generates a plurality of index values corresponding to the plurality of string data stored in the storage medium 110, respectively. In practice, the index generator 120 generates a corresponding index value for each string data according to a predetermined rule. In this embodiment, each of the plurality of index values generated by the index generator 120 is a number. Take letters or numbers in the string data as example, the index generator 120 can convert each of these characters into a corresponding number according to a mapping relationship between the character and the key number of the keypad on the mobile phone. For example, suppose that the key numbers of the keypad can be mapped to the English letters and numbers as following:
key “0”: number ‘0’;
key “1”: number ‘1’;
key “2”: number ‘2’, and letters ‘a’, ‘b’, and ‘c’;
key “3”: number ‘3’, and letters ‘d’, ‘e’, and ‘f’;
key “4”: number ‘4’, and letters ‘g’, ‘h’, and ‘i’;
key “5”: number ‘5’, and letters ‘j’, ‘k’, and ‘l’;
key “6”: number ‘6’, and letters ‘m’, ‘n’, and ‘o’;
key “7”: number ‘7’, and letters ‘p’, ‘q’, ‘r’, and ‘s’;
key “8”: number ‘8’, and letters ‘t’, ‘u’, and ‘v’; and
key “9: number ‘9’, and letters ‘w’, ‘x’, and ‘z’;

According to the above mapping relationship, the index generator 120 can convert letters ‘a’, ‘b’, or ‘c’ in the string data into a number ‘2’; convert letters ‘d’, ‘e’, or ‘f’ in the string data into a number ‘3’; and so forth. For example, suppose that the storage medium 110 stores two string data, ‘Randy’ and ‘Alex316’. The index generator 120 may convert the string ‘Randy’ into an index value ‘72639’ and convert the string ‘Alex316’ into another index value ‘2539316’ based on the above mapping relationship between characters and key numbers. Similar concepts may be adopted by the index generator 120 to convert letters of other languages into corresponding numbers. In practice, the mapping relationship between the key numbers of the keypad and letters or numbers is a design choice rather than a restriction of practical implementations of the present invention.

As described previously, in addition to letters and numbers, the string data stored in the storage medium 11 0 may contain characters of other types, such as double-byte characters, punctuation marks, or other delimiters. For each character except for letters and numbers, the index generator 120 may convert the character into a corresponding number according to an input rule of a character input method. In the following, a Chinese string [symbol] is employed as an example for illustrating the index generation of the double-byte character.

The phonetic notations of the three Chinese characters [symbol] z,3 and [symbol] are [symbol] ‘ [symbol] ’, and ‘ [symbol] ’, respectively. In step 210, the index generator 120 can convert each of the three Chinese characters into a corresponding number according to the first phonetic symbol of their phonetic notation. For example, suppose that the phonetic symbol ‘ [symbol] ’ corresponds to the key “3” of the key pad; the phonetic symbol [symbol] ’ corresponds to the key “1” ; and the phonetic symbol ‘ [symbol] ’ corresponds to the key “7”, then the index generator 120 can convert the Chinese string [symbol] into a index value ‘317’.

Note that, the index value of the Chinese string [symbol] may vary with the Chinese input method selected by the index generator 120. For example, according to the Hanyu Pinyin input method, the phonetic transcriptions of the three Chinese characters [symbol] , [symbol] and [symbol] are ‘zhang’, ‘fa’, and ‘ming’, respectively. In step 210, the index generator 120 can convert each Chinese character into a key number corresponding to the leading letter of its phonetic transcription. For instance, according to the input rules of the Hanyu Pinyin input method and the above-mentioned mapping relationship between letters and key numbers, the Chinese string [symbol] can be converted into an index value ‘936’ corresponding to the leading letters ‘zfm’ of the three characters. In practice, the input method for use in the index generation of the double-byte characters may be designed to be configurable or selectable by the user.

Similarly, for each delimiter in a string data, the index generator 120 may convert the delimiter into a corresponding number according to the input rule of the delimiter with respect to a predetermined input method. For example, the user needs to input delimiters through the key “0” in some mobile phones. In such a situation, the index generator 120 may convert each delimiter in the string data into a number ‘0’. By way of example, the index generator 120 may convert a string ‘Randy_Change’ into an index value ‘726390242643’. In some mobile phones, the user needs to utilize the key “*” to input delimiters. In this situation, the index generator 120 may convert each delimiter in the string data into a predetermined number, such as the number ‘0’ or ‘1’.

In practice, the index generator 120 may simply ignore all delimiters in the string data when generating the index value of the string data in step 210. For example, the index generator 120 may convert the string data ‘Randy_Change’ into an index value ‘72639242643’ where the delimiter, i.e., the bottom line ‘_’, is ignored.

Note that, the index generator 120 may store the index values generated in step 210 in the storage medium 110 or other storage components.

In step 220, the searching module 130 receives an input value sequence transmitted from an input module (not shown). The input module may vary with the type of the electronic device in which the data searching circuit 100 is applied. For example, if the electronic device is a mobile phone, the input module is typically the keypad of the mobile phone. If the electronic device is a PDA, the input module may be the touch panel on the PDA. In addition, the input module may be other interfaces allowing the user to input data therethrough, such as a voice-controlled module allowing the user to control the electronic device through voice, a keyboard, a handwriting panel, etc. The searching module 130 converts the input value sequence into the same data type as the index values generated in step 210. In this embodiment, the searching module 130 converts the input value sequence into a number sequence. If the data searching circuit 100 is applied in a mobile phone, the above conversion is not required due to the input value sequence transmitted from the key pad of the mobile phone is a number sequence. As shown in FIG. 1, a buffer 140 for buffering the input value sequence from the input value module may be arranged prior to the searching module 130.

In step 230, the searching module 130 selects at least one target data having an index value that partially matches the input value sequence from the plurality of string data stored in the storage medium 110. For the purpose of explanatory convenience in the following description, it is herein assumed that the storage medium 110 stores a plurality of string data and their corresponding index values as shown in following chart:

| String data: | Index value: |
|---|---|
| Alex316 | 2539316 |
| [symbol] | 317 |
| David-S | 328437 |
| Randy_Change | 72639242643 |
| Paul G. | 72854 |
| Sara W. | 72729 |
| Smith-428 | 76484428 |
| Ryan | 7926 |

When the input value sequence is ‘72’, the searching module 130 selects from the storage medium 110 the string data having an index value with a leading ‘72’ to be the target data. In this case, the searching module 130 selects three string data: ‘Randy_Change’, ‘Paul G.’, and ‘Sara W.’. The searching module 130 may temporarily store the searched results in a buffer or memory stack and may display them on a display of the electronic device so that the user can select a desired data from the searched results by utilizing the selection keys. If the user presses the key “6” of the keypad, then the input value sequence becomes ‘726’. Subsequently, the searching module 130 selects string data having an index value with a leading ‘726’ from those string data having an index value with a leading ‘72’. Consequently, the searching module 130 obtains only a single string data, in this example: Randy_Change, which matches the searching condition.

In other words, the user is only required to press the corresponding keys of the leading characters of a desired string data, and then the searching module 130 can find matched string data by comparing the number sequence from the input module with the leading portion of the index value of each string data. As a result, the utilization convenience is significantly improved. Additionally, the searching module 130 does not need to convert the number sequence into all possible character combinations nor is it required to convert the plurality of string data into corresponding number strings in step 230. As a result, the data searching speed can be greatly improved accordingly.

In practice, the index generator 120 may limit the maximum character length of each index value in step 210 to reduce the required memory space needed for storing these index values. Thereto, the index generator 120 may set a fixed character length for each index value.

For example, the index generator 120 may set the character length of each string data to M. In a preferred embodiment, if the number of non-delimiter characters of a string data is an integer N less than M, the index generator 120 converts the N non-delimiter characters into N numbers and than generates an index value according to the N numbers. For example, the index generator 120 may append P zeros to the N numbers to generates an index value with M characters where P=M−N. Taking the string data ‘Ryan’ as an example, if M is equal to 6, the index value of the string data ‘Ryan’ becomes to ‘792600’.

If the number of non-delimiter characters of the string data is greater than M, the index generator 120 may convert the first M non-delimiter characters of the string data into M numbers to form an index value of the string data. Taking the string data ‘Randy_Change’ as an example, when M is equal to 6, then the index value of the string data ‘Randy_Change’ is truncated to be ‘726392’.

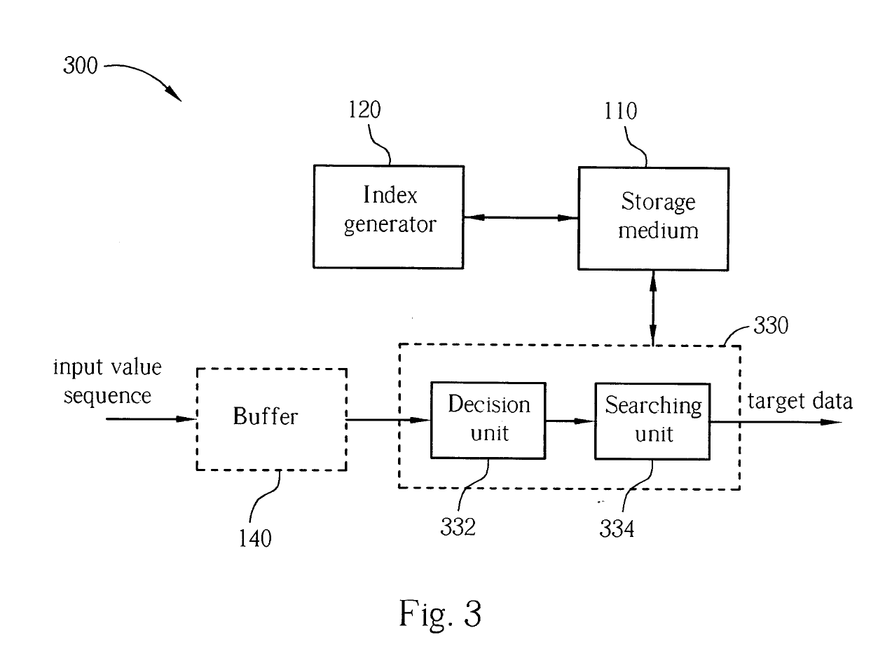

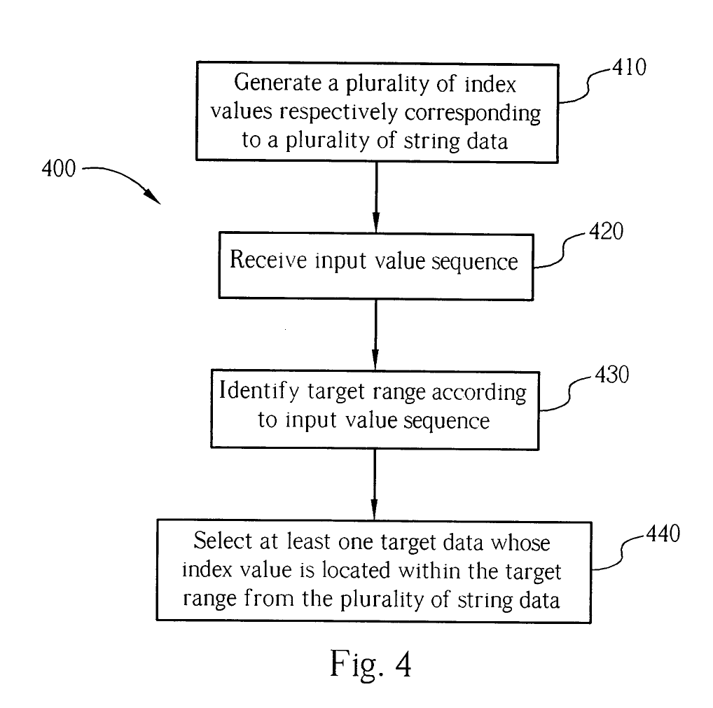

Please refer to FIG. 3 and FIG. 4. FIG. 3 shows a block diagram of a data searching circuit 300 according to a second embodiment of the present invention. FIG. 4 is a flowchart 400 illustrating a data searching method according to a second embodiment of the present invention. The data searching circuit 300 is similar to the data searching circuit 100 described previously, therefore, components having similar operations and implementations are identically labeled. One difference between the data searching circuit 300 and the data searching circuit 100 is that a searching module 330 of the data searching circuit 300 comprises a decision unit 332 and a searching unit 334. Similarly, it is herein assumed that the data searching circuit 300 is applied in a mobile phone. The operations of the data searching circuit 300 will be described in more detailed with reference to FIG. 4.

In this embodiment, the index generator 120 of the data searching circuit 300 generates an index value having M characters for each string data stored in the storage medium 110 and stores the generated index values in the storage medium 110 in step 410. The operations of the index generator 120 in step 410 are substantially the same as in the previous descriptions, and further details are therefore omitted herein for the sake of brevity. Suppose that M is equal to 6, then the index values of the above-mentioned string data are modified as follows:

| String data: | Index value: |
|---|---|
| Alex316 | 253931 |
| [symbol] | 317000 |
| David-S | 328437 |
| Randy_Change | 726392 |
| Paul G. | 728540 |
| Sara W. | 727290 |
| Smith-428 | 764844 |
| Ryan | 792600 |

In step 420, the decision unit 332 of the searching module 330 receives an input value sequence. The decision unit 332 then identifies a target range according to the input value sequence in step 430 and transmits the target range to the searching unit 334. For example, if the input value sequence received by the decision unit 332 is ‘72’, the decision unit 332 sets the target range as an interval from the index value ‘720000’ to the index value ‘729999’. If the input value sequence received by the decision unit 332 is ‘726’, the decision unit 332 sets the target range as an interval from the index value ‘726000’ to the index value ‘726999’.

In step 440, the searching unit 334 of the searching module 330 selects at least one target data whose index value is located within the target range from the storage medium 110. For example, if the target range is set as the interval from the index value ‘720000’ to the index value ‘729999’, the searching unit 334 selects string data whose index value is located within this range to be the target data. In this case, three string data, ‘Randy_Change’, ‘Paul G.’, and ‘Sara W.’ are selected.

If the user presses the key “6” of the key pad, the input value sequence becomes to ‘726’ and the decision unit 332 narrows the target range to an interval from the index value ‘726000’ to ‘726999’ correspondingly. In this case, the searching unit 334 may directly search the previous searching results for string data whose index value is located within the interval from index value ‘726000’ to ‘726999’. Since the searching range is gradually reduced, the searching unit 334 can quickly identify string data matching the searching condition. In this embodiment, only the string data ‘Randy_Change’ has an index value located within the target range. Note that, the target range is gradually reduced in this embodiment. This is merely a preferred embodiment rather than a restriction of practical implementations of the present invention. Since the searching speed is typically sufficiently quick, the searching unit 334 can re-search the overall string data in each searching run.

In this embodiment, similar to the previous embodiment, the user is only required to press the corresponding keys of the leading characters of a desired string data, and then the decision unit 332 identifies a target range according to the number sequence from the keypad of the mobile phone. Subsequently, the searching unit 334 sifts string data from the storage medium whose index value is located within the target range. Obviously, this method can significantly improve the utilization convenience as well as the foregoing embodiment.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data searching method for an electronic device storing a plurality of string data, the data searching method comprising:
generating a plurality of index values corresponding to the plurality of string data, respectively;
receiving an input value sequence, and
selecting at least one target data having the index value that partially matches the input value sequence from the plurality of string data;
wherein the plurality of index values and the input value sequence have a same data type.

2. The data searching method of claim 1, wherein the input value sequence is a number sequence.

3. The data searching method of claim 1, wherein the plurality of index values have a same character length.

4. The data searching method of claim 1, wherein the step of generating the plurality of index values comprises:
for each of the plurality of string data, converting characters in the string data into a number sequence to be an index value of the string data according to a predetermined rule.

5. The data searching method of claim 4, wherein the predetermined rule corresponds to an input rule of a character input method adopted by the electronic device.

6. The data searching method of claim 1, wherein the step of generating the plurality of index values comprises:
for each of the plurality of string data, converting non-delimiter characters in the string data into a number sequence to be an index value of the string data according to a predetermined rule.

7. The data searching method of claim 6, wherein the predetermined rule corresponds to an input rule of a character input method adopted by the electronic device.

8. A data searching circuit of an electronic device, comprising:
a storage medium for storing a plurality of string data;
an index generator coupled to the storage medium for generating a plurality of index values corresponding to the plurality of string data, respectively; and
a searching module coupled to the storage medium for receiving an input value sequence, and for selecting at least one target data having the index value that partially matches the input value sequence from the plurality of string data;
wherein the plurality of index values and the input value sequence have a same data type.

9. The data searching circuit of claim 8, wherein the input value sequence is a number sequence.

10. The data searching circuit of claim 8, wherein the plurality of index values have a same character length.

11. The data searching circuit of claim 8, wherein the index generator converts characters in a string data into a number sequence to be an index value of the string data according to a predetermined rule.

12. The data searching circuit of claim 11, wherein the predetermined rule corresponds to an input rule of a character input method adopted by the electronic device.

13. The data searching circuit of claim 8, wherein the searching module comprises:
a decision unit for identifying a target range according to the input value sequence; and
a searching unit coupled to the decision unit and the storage medium for selecting string data whose index value is located within the target range to be the target data.

14. A data searching method for an electronic device stored with a plurality of string data, the data searching method comprising:
generating a plurality of index values corresponding to the plurality of string data, respectively;
receiving an input value sequence,
identifying a target range according to the input value sequence; and
selecting at least one target data whose index value is located within the target range from the plurality of string data;
wherein the plurality of index values and the input value sequence have a same data type.

15. The data searching method of claim 14, wherein the input value sequence is a number sequence.

16. The data searching method of claim 14, wherein the plurality of index values have a same character length.

17. The data searching method of claim 14, wherein the step of generating the plurality of index values comprises:
for each of the plurality of string data, converting characters in the string data into a number sequence to be an index value of the string data according to a predetermined rule.

18. The data searching method of claim 17, wherein the predetermined rule corresponds to an input rule of a character input method adopted by the electronic device.

19. The data searching method of claim 14, wherein the step of generating the plurality of index values comprises:
for each of the plurality of string data, converting non-delimiter characters in the string data into a number sequence to be an index value of the string data according to a predetermined rule.

20. The data searching method of claim 19, wherein the predetermined rule corresponds to an input rule of a character input method adopted by the electronic device.
